(19) United States
(12) Patent Application Publication
(10) Pub. No.: US 2013/0327114 A1
(43) Pub. Date: Dec. 12, 2013

(54) Process for preparing blister base parts from cold-formable laminate

(71) Applicants: Erwin Pasbrig, Singen (DE); Oliver Brandl, Konstanz (DE)

(72) Inventors: Erwin Pasbrig, Singen (DE); Oliver Brandl, Konstanz (DE)

(21) Appl. No.: 13/986,432

(22) Filed: May 2, 2013

Related U.S. Application Data
(62) Division of application No. 11/992,853, filed on Sep. 16, 2008, now abandoned.

(30) Foreign Application Priority Data
Oct. 12, 2005 (EP) 05405583.5
Oct. 4, 2006 (EP) PCT/EP2006/009567
Dec. 8, 2006 (EP) 05405692.4

(51) Int. Cl. B29C 67/00

(52) U.S. Cl. CPC B29C 67/0029
USPC 72/347

(57) ABSTRACT

A process for utilizing a cold-formable laminate (20, 40) to produce base parts (10) of blister packagings (10) for pharmaceutical products (14) which are freeze-dried in the base parts (10). Laminate (20, 40) is made of an aluminum foil (26, 46) covered on both sides with plastics material. Laminate (20, 40) can have several different layer sequences.

This application is a continuation of U.S. application Ser. No. 11/992,853, filed on Mar. 31, 2008, that has priority benefit of PCT/EP2006/009567, filed on Oct. 4, 2006, that has priority benefit of European Patent Application 05405583.5, filed on Oct. 12, 2005, and of European Patent Application 05405692.4, filed on Dec. 8, 2005.

The invention relates to a cold-formable laminate made of an aluminium foil covered on both sides with plastics material for producing base parts of blister packagings for pharmaceutical products which are freeze dried in wells in the base part.

The invention also relates to a process of utilizing the invention cold-formable laminate to produce base parts of blister packagings for pharmaceutical products which are freeze-dried in wells in the base parts.

The invention further relates to a process of producing the blister packagings containing freeze-dried pharmaceutical products in the wells of the base parts.

Cold-formable laminates made of an aluminium foil covered on both sides with plastics material are used, inter alia, for producing base parts of blister packagings for pharmaceutical products. Wells for receiving individual tablets or other forms of individual doses are formed in the base parts. The aluminium foil is used here primarily as a barrier layer against the passage of water vapour and gases and protects the products primarily from absorbing or giving off moisture.

Conventional laminates for producing base parts of blister packagings for pharmaceutical products frequently have the structure oPA/aluminium foil/sealing layer. Conventional sealing layers consist of 15 to 100 μm PVC, 20 to 60 μm PP or 30 to 50 μm PE. After filling the wells, an optionally peelable outer foil is sealed against the base parts. Conventional outer foils are optionally aluminium foils which are coated with plastics material, covered with film or lacquered.

Freeze-dried pharmaceutical products are a new form of drug delivery system (DDS). With this form of administration, the active ingredient is released in the throat and reaches the blood circulation by way of the mucous membranes.

A first method of producing these DDSs is the production of freeze-dried pharmaceutical products and the subsequent filling of the blisters similarly to the packaging of conventional tablets.

A second method for producing these DDSs consists in introducing the pharmaceutical product in liquid form into the wells which are arranged in the base part of a blister packaging and carrying out the freeze drying directly in the wells. However, in practice it has been shown that laminates made of an aluminium foil coated with plastics material tend to roll in under the influence of the temperature change during the freeze drying process.

As a consequence of the production process, in the method with freeze drying carried out directly in the blister base parts, foil portions with blister base parts are punched after the cold-forming of the laminate and the wells thereof are then filled with the pharmaceutical product present in liquid form. The foil portions with the filled wells are then continuously guided through a freezing tunnel. So no liquid can come from the wells onto the sealing layer, the foil portions have to lie flat during the freezing process, i.e. no distortion may occur.

A laminate which is made of an aluminium foil with plastics material layers arranged on both sides is known from EP-A-0 646 367, the layers having substantially the same thermal coefficients of expansion to avoid distortion of the blister base parts during the freeze drying. This condition is fulfilled with an arrangement of identical plastics material layers on both sides.

The invention is based on the object of providing a process for utilizing the laminate of the type mentioned at the outset suitable for producing base parts of blister packagings for pharmaceutical products which are freeze-dried directly in the base part, without the plastics material layers on both sides of the aluminum foil having to have the same thermal coefficients of expansion. The object is achieved by such invention production process.

The invention is also based on the object of providing a process of producing the blister packaging containing freeze-dried pharmaceutical products in the wells in the base parts, which have been produced from the invention laminate as part of the process. The object is achieved by such invention production process.

The invention is based on the object of providing a laminate of the type mentioned at the outset which is suitable for producing base parts of blister packagings for pharmaceutical products which are freeze dried directly in the base part, without the plastics material layers arranged on both sides of the aluminium foil having to have the same thermal coefficients of expansion.

The object is achieved according to the invention in that the laminate has the layer sequence
layer A/layer B/aluminium foil/layer C/layer D, wherein the layer A is a film 10 to 100 μm thick made of COC/PE blend or coextruded COC/PE, the layers B and C are films 10 to 50 μm thick made of oPA, oPP or PET and the layer D is a film 10 to 100 μm thick made of COC/PE blend, coextruded COC-PE or PVC, the layers A and D being different, or
layer A/layer B/aluminium foil/layer C/layer D, wherein the layer A is a film 4 to 20 μm thick made of oPP or PET, the layers B and C are films 10 to 50 μm thick made of oPA or PET and the layer D is a film 10 to 100 μm thick made of COC/PE blend or coextruded COC/PE, or
layer B/aluminium foil/layer C/layer D, wherein the layers B and C are films 10 to 50 μm thick made of oPA or PET and the layer D is a coating made of PE with a grammage of 8 to 40 g/m², or
layer B/aluminium foil/layer C/layer D, wherein the layers B and C are films 10 to 50 μm thick made of oPA or PET and the layer D is a film 10 to 100 μm thick made of COC/PE blend or coextruded COC/PE.

The films of layers A and D made of COC/PE blend, coextruded COC/PE or PVC preferably have a thickness of 15 to 60 μm, the films of the layers A made of oPP or PET have a thickness of 6 to 10 μm and the films of layers B and C have a thickness of 12 to 30 μm. If there is a coating, the layer D has a preferred grammage of 10 to 30 g/m².

The layer D forms the later sealing layer when sealing an outer foil on a base part of a blister packaging produced from the laminate according to the invention.

Apart from the special layer structure, the different chemical composition and/or the different structure of the two outer layers of the laminate is a fundamental feature of the invention.

The aluminium foil is in a flexible state and has a thickness of 20 to 100 μm, preferably 30 to 60 μm.

The individual layers can be connected by covering with solvent-based, solvent-free or aqueous adhesives, by extrusion covering, hot calendering and/or extrusion coating with and without primer.

The film combinations preferred for the laminates according to the invention are compiled in Table 1. The abbreviated designations of the plastics materials on which the films are based mean:

| | | | |
|---|---|---|---|
| oPA | oriented polyamide | PE | polyethylene |
| oPP | oriented polypropylene | PVC | polyvinylchloride |
| PET | polyethylene terephthalate | COC | cycloolefin copolymer |
| COP | cycloolefin polymer | | |

TABLE 1
Preferred laminate structures

| No. | Layer A | Layer B | Al | Layer C | Layer D |
|---|---|---|---|---|---|
| 1 | 25 μm COC/PE blend | 15 μm oPA | 45 μm | 15 μm oPA | 25 μm COC/PE coex |
| 2 | 25 μm COC/PE blend | 15 μm oPA | 60 μm | 15 μm oPA | 25 μm COC/PE coex |
| 3 | 25 μm COC/PE blend | 25 μm oPA | 45 μm | 25 μm oPA | 25 μm COC/PE coex |
| 4 | 25 μm COC/PE blend | 25 μm oPA | 60 μm | 25 μm oPA | 25 μm COC/PE coex |
| 5 | 40 μm COC/PE blend | 15 μm oPA | 45 μm | 15 μm oPA | 40 μm COC/PE coex |
| 6 | 40 μm COC/PE blend | 15 μm oPA | 60 μm | 15 μm oPA | 40 μm COC/PE coex |
| 7 | 40 μm COC/PE blend | 20 μm oPA | 45 μm | 20 μm oPA | 40 μm COC/PE coex |
| 8 | 40 μm COC/PE blend | 20 μm oPA | 60 μm | 20 μm oPA | 40 μm COC/PE coex |
| 9 | 25 μm COC/PE blend | 25 μm oPA | 45 μm | 23 μm PET | 25 μm COC/PE coex |
| 10 | 25 μm COC/PE blend | 25 μm oPA | 60 μm | 23 μm PET | 25 μm COC/PE coex |
| 11 | 25 μm COC/PE coex | 15 μm oPA | 45 μm | 15 μm oPA | 25 μm COC/PE blend |
| 12 | 25 μm COC/PE coex | 15 μm oPA | 60 μm | 15 μm oPA | 25 μm COC/PE blend |
| 13 | 40 μm COC/PE blend | 20 μm oPP | 45 μm | 20 μm oPP | 40 μm COC/PE coex |
| 14 | 40 μm COC/PE blend | 20 μm oPP | 60 μm | 20 μm oPP | 40 μm COC/PE coex |
| 15 | 40 μm COC/PE coex | 20 μm oPA | 45 μm | 20 μm oPA | 15 μm PVC |
| 16 | 40 μm COC/PE coex | 20 μm oPA | 60 μm | 20 μm oPA | 30 μm PVC |
| 17 | 25 μm COC/PE blend | 23 μm PET | 45 μm | 23 μm PET | 25 μm COC/PE coex |
| 18 | 25 μm COC/PE blend | 23 μm PET | 60 μm | 23 μm PET | 25 μm COC/PE blend |
| 19 | 6 μm PET | 15 μm oPA | 45 μm | 15 μm oPA | 25 μm COC/PE coex |
| 20 | 8 μm oPP | 15 μm oPA | 60 μm | 15 μm oPA | 25 μm COC/PE blend |
| 21 | 9 μm PET | 25 μm oPA | 45 μm | 25 μm oPA | 25 μm COC/PE coex |
| 22 | 10 μm oPP | 25 μm oPA | 60 μm | 25 μm oPA | 25 μm COC/PE blend |
| 23 | 9 μm PET | 25 μm oPA | 45 μm | 25 μm oPA | 40 μm COC/PE coex |
| 24 | 10 μm oPP | 25 μm oPA | 60 μm | 25 μm oPA | 40 μm COC/PE blend |
| 25 | 6 μm PET | 15 μm oPA | 45 μm | 12 μm PET | 25 μm COC/PE coex |
| 26 | 8 μm oPP | 15 μm oPA | 60 μm | 12 μm PET | 25 μm COC/PE blend |
| 27 | 9 μm PET | 25 μm oPA | 45 μm | 23 μm PET | 25 μm COC/PE coex |
| 28 | 10 μm oPP | 25 μm oPA | 60 μm | 23 μm PET | 25 μm COC/PE blend |
| 29 | 9 μm PET | 23 μm PET | 45 μm | 23 μm PET | 40 μm COC/PE coex |
| 30 | 10 μm oPP | 23 μm PET | 60 μm | 23 μm PET | 40 μm COC/PE blend |
| 31 | | 15 μm oPA | 45 μm | 15 μm oPA | 10 g/m² PE |
| 32 | | 15 μm oPA | 60 μm | 15 μm oPA | 10 g/m² PE |
| 33 | | 25 μm oPA | 45 μm | 25 μm oPA | 15 g/m² PE |
| 34 | | 25 μm oPA | 60 μm | 25 μm oPA | 15 g/m² PE |
| 35 | | 25 μm oPA | 45 μm | 23 μm PET | 15 g/m² PE |
| 36 | | 25 μm oPA | 60 μm | 23 μm PET | 15 g/m² PE |
| 37 | | 23 μm PET | 45 μm | 23 μm PET | 15 g/m² PE |
| 38 | | 23 μm PET | 60 μm | 23 μm PET | 15 g/m² PE |
| 39 | | 15 μm oPA | 45 μm | 15 μm oPA | 25 μm COC/PE coex |
| 40 | | 15 μm oPA | 60 μm | 15 μm oPA | 25 μm COC/PE blend |
| 41 | | 25 μm oPA | 45 μm | 25 μm oPA | 25 μm COC/PE coex |
| 42 | | 25 μm oPA | 60 μm | 25 μm oPA | 25 μm COC/PE blend |
| 43 | | 25 μm oPA | 45 μm | 25 μm oPA | 40 μm COC/PE coex |
| 44 | | 25 μm oPA | 60 μm | 25 μm oPA | 40 μm COC/PE blend |
| 45 | | 15 μm oPA | 45 μm | 12 μm PET | 25 μm COC/PE coex |
| 46 | | 15 μm oPA | 60 μm | 12 μm PET | 25 μm COC/PE blend |
| 47 | | 25 μm oPA | 45 μm | 23 μm PET | 25 μm COC/PE coex |
| 48 | | 25 μm oPA | 60 μm | 23 μm PET | 25 μm COC/PE blend |
| 49 | | 23 μm PET | 45 μm | 23 μm PET | 40 μm COC/PE coex |
| 50 | | 23 μm PET | 60 μm | 23 μm PET | 40 μm COC/PE blend |

A preferred area of application of the laminate according to the invention is the production of base parts of blister packagings for pharmaceutical products which are freeze dried in wells in the base part.

Further advantages, features and details of the invention emerge from the following description of preferred embodiments and with the aid of the drawings, in which, schematically:

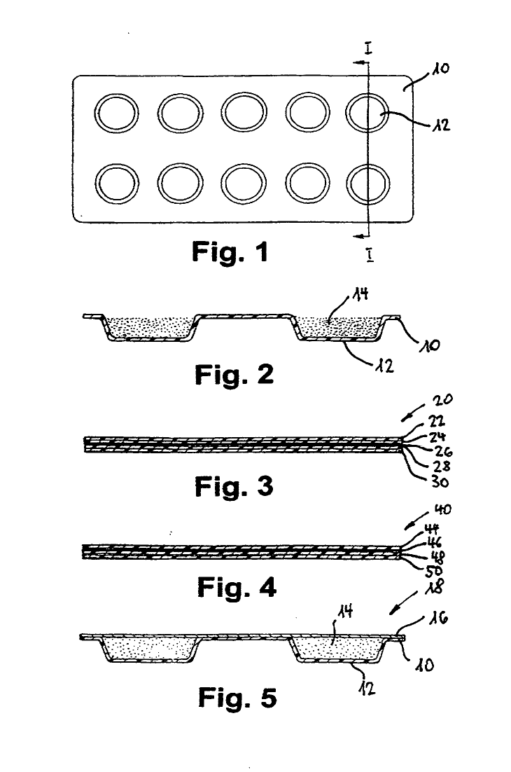

FIG. 1 shows a plan view of a base part of a blister packaging;

FIG. 2 shows a section through the base part of FIG. 1 along the line I-I;

FIG. 3 shows a cross section through a first embodiment of a laminate for producing blister base parts;

FIG. 4 shows a cross section through a second embodiment of a laminate for producing blister base parts;

FIG. 5 shows a cross section through a blister packaging made of a base part with a sealed-on outer foil.

A base part 10 of a blister packaging shown in FIGS. 1 and 2 consists of a laminate, from which depressions in the form of wells 12 are formed by cold-forming. A single dose 14 in liquid form is located in each well 12.

A first laminate 20 which is shown in FIG. 3 for producing the base part 10 has the following layer structure from the outside to the inside:

| | | |
|---|---|---|
| 22 | layer A | for example film made of COC/PE blend, 40 μm thick, |
| | | or film made of PET, 9 μm thick |
| 24 | layer B | for example film made of oPA, 20 μm thick |
| 26 | aluminium | for example 60 μm thick |
| | foil | |
| 28 | layer C | for example film made of oPA, 20 μm thick |
| 30 | layer D | for example film made of COC/PE coex, 40 μm thick |

The layer A is the later outside of a blister base part produced from the laminate 20 and the layer D is the sealing side for sealing on an outer foil.

A second laminate 40 shown in FIG. 4 for producing the base part 10 has the following layer structure from the outside to the inside:

| | | |
|---|---|---|
| 44 | layer B | for example film made of oPA, 15 μm thick |
| 46 | aluminium foil | for example 45 μm thick |
| 48 | layer C | for example film made of oPA, 15 μm thick |
| 50 | layer D | for example coating of PE, 15 g/m², or film made of |
| | | COC/PE coex, 40 μm thick |

The layer B is the later outside of a blister base part produced from the laminate 20 and the layer D is the sealing side for sealing on an outer foil.

During freeze drying with a base part 10 shown in FIG. 1, individual doses 14 of a pharmaceutical product in liquid form are introduced into the wells 14. The base part 10 then runs through a freezing station, in which the individual doses 14 rapidly freeze. The base parts 10 with the frozen individual doses 14 are then freeze dried in a chamber under a vacuum. After the freeze drying, the base parts 10 are closed by sealing on an outer foil 16, for example an aluminium foil, which can preferably be peeled from the base part 10, to produce the finished blister packaging 18.

1-6. (canceled)

7. A process comprising utilizing a cold-formable laminate (20, 40) for producing base parts (10) of blister packagings (18) for pharmaceutical products (14) which are in wells (12) in the base part (10):
layer A (22)/layer B (24)/aluminum foil (26)/layer C (28)/layer D (30), wherein the layer A is a film 10 to 100 μm thick made of COC/PE blend or coextruded COC/PE, the layers B and C are each a film 10 to 50 μm thick made of oPA, oPP or PET, and the layer D is a film 10 to 100 μm thick made of COC/PE blend, coextruded COC/PE or PVC, the layers A and D are different; or
layer A (22)/layer B (24)/aluminum foil (26)/layer C (28)/layer D (30), whereing the layer A is a film 4 to 20 μm thick made of oPP or PET, the layers B and C are each a film 10 to 50 μm thick made of oPA or PET, and the layer D is a film 10 to 100 μm thick made of COC/PE blend or coextruded COC/PE, or
layer B (44)/aluminum foil (46)/layer C (48)/layer D (50), wherein the layers B and C are each a film 10 to 50 μm thick made of oPA or PET, and the layer D is a coating made of PE with a grammage of 8 to 40 g/m², or
layer B (44)/aluminum foil (46)/layer C (48)/layer D (50), wherein the layers B and C are each a film 10 to 50 μm thick made of oPA or PET, and the layer D is a film 10 to 100 μm thick made of COC/PE blend or coextruded COC/PE.

8. The process according to claim 7, wherein in the laminate (20, 40), that is being utilized to produce base parts (10) of blister packagings (18) for pharmaceutical products (14) which are freeze-dried in wells (12) in the base part (10), the films of the layers A (22) and D (30, 50) are made of COC/PE blend or coextruded COC/PE or PVC and have a thickness of 15 to 60 μm.

9. The process according to claim 7, wherein in the laminate (20, 40), that is being utilized to produce base parts (10) of blister packagings (18) for pharmaceutical products (14) which are freeze-dried in wells (12) in the base (10), the films of the layers A (22) which are made of oPP or PET have a thickness of 6 to 10 μm.

10. The process according to claim 7, wherein in the laminate (20,40), that is being utilized to produce base parts (10) of blister packagings (18) for pharmaceutical products (14) which are freeze-dried in wells (12) in the base (10), the films of the layers B (24, 44) and C (28, 48) have a thickness of 12 to 30 μm.

11. The process according to claim 7, wherein in the laminate (20, 40), that is being utilized to produce base parts (10) of blister packagings (18) for pharmaceutical products (14) which are freeze-dried in wells (12) in the base (10), the coating of the layer D (50) has a grammage of 10 to 30 g/m².)

12. The process according to claim 7, wherein in the laminate (20, 40), that is being utilized to produce base parts (10) of blister packagings (18) for pharmaceutical products (14) which are freeze-dried in wells (12) in the base (10), the aluminum foil (26n 46) has a thickness of 20 to 100 μm.

13. The process according to claim 7, wherein in the laminate (20, 40), that is being utilized to produce base parts (10) of blister packagings (18) for pharmaceutical products (14) which are freeze-dried in wells (12) in the base part (10), the aluminum foil (26, 46) has a thickness of 30 to 60 μm.
